(19) United States
(12) Patent Application Publication
(10) Pub. No.: US 2018/0030674 A1
(43) Pub. Date: Feb. 1, 2018

(54) Spreader rate calculating apparatus and vehicle

(71) Applicant: Stoltz Mfg LLC, Morgantown, PA (US)

(72) Inventors: Bernard J. Hershberger, Lancaster, PA (US); Tyler Martikainen-Watcke, Reading, PA (US)

(73) Assignee: Stoltz Mfg LLC, Morgantown, PA (US)

(21) Appl. No.: 15/224,940

(22) Filed: Aug. 1, 2016

(51) Int. Cl. E01C 19/20; B60W 30/14

(52) U.S. Cl. CPC E01C 19/201; B60W 30/143; E01C 2019/2065; B60W 2720/10; B60W 2520/10

(57) ABSTRACT

A method for calculating the change in mass over time of a storage area holding a load, while components of the load are being removed or added, and while the storage area is subjected to changing vertical acceleration, is disclosed. The method uses a computer to compare the measured weight of a load with a known mass to the measured weight of the variable load and calculated the mass of the variable load. Periodic measurements and calculations allow the change of the variable load over time to be determined. Controls influencing the addition and removal of load components maybe controlled in response to the calculated change in mass to maintain targeted rates of change.

### FIELD OF THE INVENTION

The subject matter of this application pertains to methods of adjusting the dispersal rate of material from a hopper or storage area to minimize variation in the amount of material dispersed per unit of area or time caused by force and speed changes du to the movement of the hopper or storage area. In particular, the subject matter of this application pertains to methods of adjusting the amount of material dispersed by a, e.g., spreader truck, as the truck moves along a path by measuring the weight of the remaining material, the speed of the truck, and the speed of the conveyor or auger moving the material towards the ejection point, while correcting the variance in measured weight caused by the truck traveling over uneven terrain.

### BACKGROUND

Soil stabilization is the process of improving certain characteristics of soil through the addition of materials. It is most commonly used to increase the load bearing capability of soil and to harden it. This process results in a subbase and base course suitable for serving as a foundation for roads, parking lots, runways, driveways, and other pavement structures. A subbase may also be the top layer for certain footpaths or asphalt-free roads (often colloquially called “gravel roads.”)

Soil stabilization increases the soil strength, which increases the structural integrity of pavement placed on top of it, thereby lowering maintenance costs and maximizing the lifespan of the pavement.

Several types of materials may be used alone or in combination to stabilize the soil, depending on the natural characteristics of the soil itself and on the intended purpose of the final product. among these compounds are Portland cement, lime, gypsum, fly ash, silica, bentonite and certain metal oxides. One common characteristics of these compounds is that they are dusty.

Often, the stabilizing compounds are loaded into a spreader truck, and an ejection means such as a conveyor or auger system moves the material towards an ejection point where it falls to the surface, depositing a layer of material as it drives over the work area. Additional material may then be laid, or otherwise processed.

A similar spreading scheme may be used to spread other materials, such as ground-conditioning adjuncts like agricultural lime, manure, or chemical fertilizers. In these applications, as in the soil stabilization example, the material to be spread is loaded into the truck, the truck drives over the area to be covered and the ejection means pushes the truck's load towards the truck's egress point where the material falls to the surface.

Commonly the ejection means is adjusted to eject a certain volume of material per unit time. For example, if an application requires 1 kg of material to be deposited every meter squared, and each cubic meter of material has a mass of 1000 kg, then we know that one cubic meter of material should be deposited every 1000 square meters. The speed of the material mover, the width of the ejection point, and the speed of the truck can then be adjusted before the application begins so the appropriate amount of material is ejected.

One problem with this approach is that it requires the driver to maintain a fairly steady speed which may be challenging, especially if the truck is driving over a rough, uneven, and slanted terrain.

Variations in the truck's speed can be largely controlled for by constructing a feedback loop such that increases or decreases in truck speed would cause the speed of the ejection speed to correspondingly adjust to keep the amount deposited per area consistent.

However it is much more difficult to accurately deposit a certain mass of material by ejecting a certain volume, even if the weight of the load and its volume is known, because the density of the components within a load can vary widely due to factors such as particle size and load settling. Further, material flow characters can vary due to factors such as e.g., particle size, shape, and smoothness. Unfortunately for a user, a load of e.g., gravel is not homogenous and can be comprised of rocks of different sizes, shapes, and densities. Even chemical fertilizers are comprised of particles of differing shape, volume, and density. Because of this, although the speed of the truck and of the ejection means may be set before material application begins, and although the average mass ejected over the entire application area may be accurate, any two sections of the application area may receive widely varying amounts of material.

To a certain extent, these irregularities in particle size and density can be controlled by monitoring the change in weight of the truck's load and having this change either the ejection mean's rate, the speed of the truck, or both. For example, a computerized system could monitor the weight of the load as measured by an on-board truck scale such as the Vulcan On-Board Scales manufactured by Stress-Tek, Inc of Kent, Wash., calculate the optimal speed of the ejection means, and reduce or increase the rate of the ejection means as needed so that a consistent amount of material is ejected. To be most useful, such a computerized system should also detect or calculate the actual speed of the truck and control for that variable by either further adjusting the speed of the ejection means or by controlling the speed of the truck.

A computerized system which monitors the change in weight of a truck's load and adjusts the volume of material ejected per unit area transversed is much more useful for applications requiring precise coverage than the more simplistic methods previously described. However since the scales measure weight, not mass, changes in vertical acceleration will distort the measurements. For example, if the ejection rate of material is steady as the truck bounces over rough terrain, the measured weight of the load will be the result of the mass of the load and the vertical acceleration of the load and this weight will momentarily be more or less than it would be if the truck was not moving or moving across a smoothly paved surface. Since spreader trucks are usually used on rough terrain there is almost constant bouncing and therefore, almost constant fluctuations in the load's weight, making precise control of the material ejection rate difficult if not impossible.

### SUMMARY

The subject matter of this application pertains to methods and devices for weighing loads in motion. More particularly, it pertains to methods and devices for measuring the weight of a load in motion, calculating the vertical acceleration of said load, and using those values to determine the mass of the load. Even more particularly, it pertain to methods and devices for calculating the mass of a load in motion from it's measured weight and vertical acceleration, comparing this mass to previously calculated masses of the load, and changing at least one variable in response to the mass change.

One objective of the subject matter of this application is to provide a method for calculating and monitoring the mass of a load while the load is in motion. Another objective to the subject matter of this application is to provide a method of changing the rate of material ejected in response to changes in mass of the load over time to maintain a target mass of material ejected per unit area. Yet another objective of the subject matter of this application is to provide a system wherein the ejection rate of material from a spreader truck is controlled by manipulating the speed of the ejection means, the truck itself, or both, so that a uniform mass of material per unit area is deposited and the impact on the measured weight of the load by vertical acceleration is minimized or eliminated.

The subject matter of this application meets these objectives.

The ejection rate calculating system comprises a storage area for holding a load made of components, at least one scale weighing the storage area, at least one reference scale weighing a known mass, and a computing system. Most useful embodiments of the subject matter of this application comprise a vehicle, such as a spreader truck, which further comprises an accelerator, an ejection point, an ejection means for moving the load's components to the ejection point, a storage area for holding a load made of components, at least one scale weighing the storage area, at least one reference scale weighing a known mass, and a computing system.

In the most typical use envisioned by the applicant, a spreader truck carries a load comprised of components, e.g., fertilizer or Portland cement in its storage area. The spreader truck has an ejection point with a known width through which the load's components fall as they are ejected. The storage area rests on at least one storage area scale and the storage area scale or scales periodically measures the weight of the storage area and transmits this information to a computer. Another reference scale measures the weight of a known mass at approximately the same time as the measurements from the storage area scale or scales and also transmits its information to a computer. A user determines the target mass of desired load components per unit area and calculates the speed of the ejection means required to deposit the target mass through the ejection point as a certain truck speed. Most often, these calculations will be done by computerized means. If the load's components are equally sized and shaped, and have the same density, as long as the truck and the ejection means maintain a steady speed the target mass per unit area of the load's components will be deposited on the ground. However, it is rare to operate a spreader truck under such perfect conditions, so the computer in this embodiment of the invention calculates the change in mass of the load per unit time and outputs a signal to the ejection means as necessary to adjust the speed of the ejection means, and thereby, the ejection rate. At the truck moves over rough terrain, it will bounce and the measured weight of the load will fluctuate, potentially causing erratic signals to reach the ejection means. The effect of this bouncing is eliminated or nearly eliminated by contemporaneously measuring the weight of the known mass, and calculating the vertical acceleration of the known mass. Once the vertical acceleration is found, this value can be used to determine the mass of the load based on the load's measured weight. The computer then sends a signal to the ejection means to adjust the ejection rate. In another preferred embodiment, the computer also receives an input of the truck's speed which is also used to calculate the speed of the ejection means to reach the target ejection rate. The computer may also send an output to the trucks to adjust the speed of the truck itself in addition to the ejection means.

### BRIEF DESCRIPTION

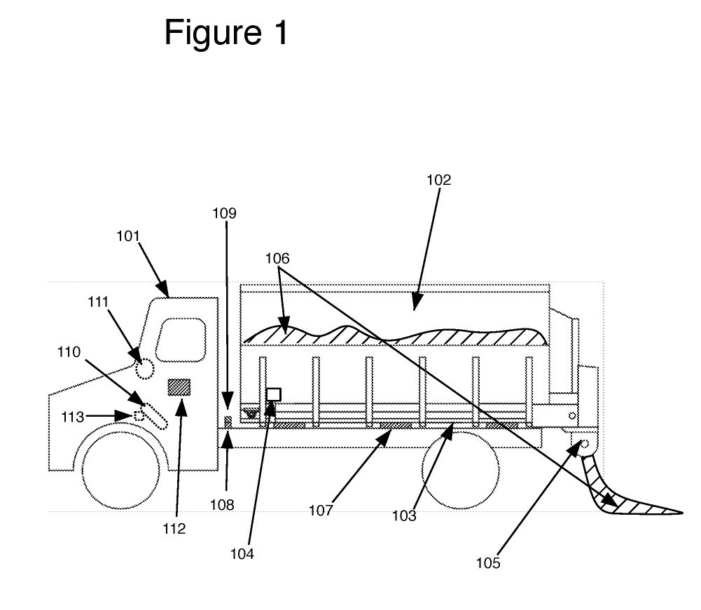

FIG. 1 is an illustration of a spreader truck in built in accordance with the disclosed dispersal rate calculating apparatus.

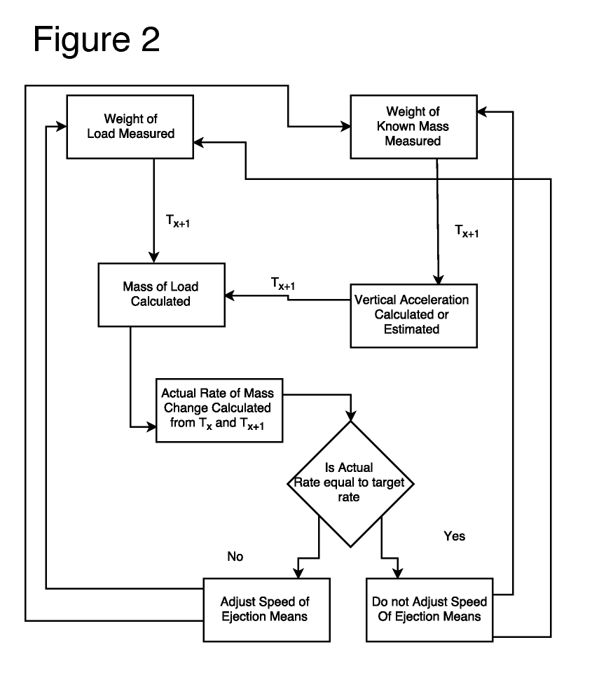

FIG. 2 is a flowchart illustrating the inputs and outputs of the dispersal rate calculating apparatus.

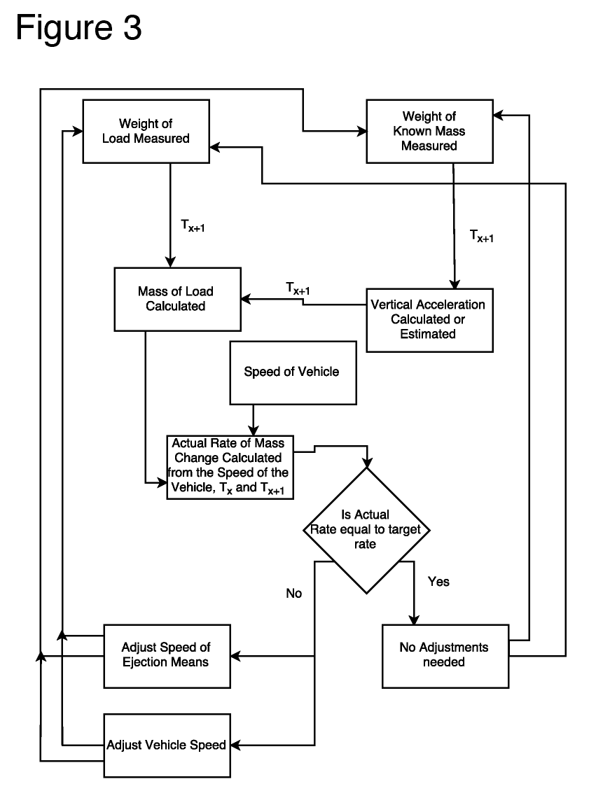

FIG. 3 is a flowchart illustrating the inputs and outputs of an alternate dispersal rate calculating apparatus.

### DETAILED DESCRIPTION

The following description and drawings referenced therein illustrate embodiments of the application's subject matter. They are not intended to limit the scope. Those familiar with the art will recognize that other embodiments of the disclosed method are possible. All such alternative embodiments should be considered within the scope of the application's disclosure.

Each reference number consists of three digits. The first digit corresponds to the figure number in which that reference number is first shown. Reference numbers are not necessarily discussed in the order of their appearance in the figures.

The subject matter of this application is described as a spreader truck comprising the subject matter of this application. However, the inventive concepts can be applied to different vehicles and apparatuses. One such alternate vehicle or apparatus is a trailer-mounted spreader. The choice of describing a spreader truck is for convenience and simplicity and should not be determined to narrow the scope of the claims; rather, the claims should be given their widest possible meaning in the light of the disclosure.

The term “ejection means” is used to refer to the machinery which causes components of the load to move towards the point where they exit the storage area. Most commonly this machinery is a conveyor or auger system, however in some spreader trucks the ejection means further comprises an adjustable gate that limits the amount of material capable of passing to the point of exit from the truck. As used, “ejection means” should be understood to include the machinery moving the load components and, if present, any doors or gates limiting passage of the load components.

A spreader truck (101) comprises a storage area (102), an ejection means (103), and ejection means controller (104), and an ejection point (105). The storage area may contain a load comprised of components (106). The spreader truck further comprises at least one storage area scale (107) and at least one reference scale (108). The storage area scale or scales are mounted to the truck to support the storage area and measure its weight. The reference scale or scales are mounted to the truck and measure the weight of a known mass (109). The known mass may either be a mass coupled to the reference scale, or the mass may be integral to the reference scale as a scale platform, or it may be merely atmospheric pressure. The spreader truck further comprises an acceleration means (110) which control the speed of the truck itself and a speedometer (111). The spreader truck further comprises a computer (112) which receives inputs from the storage area scales and the reference scale. The computer sends output to the truck's ejection means controller. In some embodiments, the computer also receives input from the speedometer. In other embodiments the truck further comprises an acceleration controller (113) and the computer can receive input from the speed monitor and send output to the acceleration controller.

In use, the spreader truck's storage area is filled with a load made of components to be spread. For example, a storage area could be filled with granules of hydrated lime for drying a construction site. In that example, each granule is a component of the load. The storage area is supported in part by one or more storage area scales. Normally more than one storage area scale would be used to control for variations across the storage area although some designs may only require one scale.

As the truck is set to being its distribution path a user initiates the ejection means which moves the load components towards one or more ejection points in the storage area, ejecting a certain volume of components per unit time (the ejection rate). As the volume of material ejected is easier to control than the mass of material, the density of a representative fraction of the load is calculated and this used to determine the volume needed to ejected to deliver the desired mass. This ejection means is commonly a conveyor system running along the base of the load or a similarly located auger. The initial rate of the ejection means may be manually set or controlled by software running on the truck's computer sending output to the ejection means controller to maintain a target ejection rate of the load's components.

If the spreader truck maintains a steady pace, the mass of load components deposited per unit area is an equation based on the size of the ejection point or points and the rate of the ejection means. However, most loads are not comprised of equally sized, shaped, and dense components. The components may be of uneven density, become partially crushed, or become compacted into clumps. Because of this, volumetric measurement is only an approximation of the mass deposited. To control for this the storage area scale or scales (107) periodically outputs the measured weight of the load (106) to the computer (112) which outputs to the ejection means controller (104) to change the speed of the ejection means (103) as required. In those designs in which the ejection means further comprises a door or gate, the computer may also output a signal to the gate or door causing it to close or open. The interval between outputs depends on the resolution needed by the application and the speed of the truck. For example, for a slow moving spreader truck loaded with compost, it may only be necessary to monitor for large discrepancies indicative of a mechanical failure. For such an application, measurements may only be needed every e.g., 30 seconds. For other applications, such as spreading chemical fertilizer on a field to correct measured nutrient deficits, where too much or too little can have deleterious effects and waste money, a proper interval may be 5 seconds or less.

Under almost all conditions, the spreader truck will be driving over uneven and often very rough terrain, causing the truck to bounce and the weight measurements to fluctuate. As anyone who has used a scale to weight themselves realizes, bouncing and even slight jostling can cause a scale's measurement to wildly fluctuate. This phenomena is due to the force generated by lateral movements. In classical physics, this is described by the Force Equation, where Force=Mass*Acceleration. When the mass being weighed is steady, then acceleration is the acceleration of gravity and the force is the measured weight. When the mass is moving vertically, its measured weight changes due to its acceleration, either away from the ground to towards it. Since the spreader truck's load is nearly always bouncing as it travels, simply weighing the mass of the load is inaccurate.

To correct for this the spreader truck further comprises at least one reference scale (108) which supports a known mass (109). Even if no additional mass is placed on the reference scale, there is still a mass associated with the scale itself, which is normally calibrated to zero before use. The reference scale or scales outputs it's measured weight to the computer, contemporaneously with the weight outputs of the storage area scales. Software stored in the computer's memory calculates the mass of the load from the weight data received from the storage area's scale or scales, the reference scale or scales, and the reference scales's known mass. Although the exact calculation may differ, an example process would calculate the vertical acceleration of the reference scale's know mass with the equation Acceleration=Force/Mass, where Force is the measured weight and Mass is the known mass. Under most typical conditions, the acceleration acting on the reference scale's mass will be the same as the acceleration acting on the storage area's load. Accordingly, the software uses the calculated acceleration to determine the mass of the storage area's load by using the equation Mass=Force/Acceleration, where Force is the weight measured by the storage area scale (or the mean measured weight by multiple storage area scales). The computer then compares the periodic change in calculated mass of the load per unit time to the target ejection rate and outputs signals to the ejection means controller causing its speed to change in order to maintain the target ejection rate. In an alternative embodiment, the reference scale and it's supported known mass is replaced with an accelerometer. Such “accelerometer” embodiments function in substantially the same way and yield substantially the same results as the discussed “reference scale” embodiments.

This still assumes that the vehicle's speed is steady, however even the most careful human driver will have difficulty maintaining a set speed, especially over uneven terrain. To compensate for this, a most preferred embodiment of the subject matter of this application further comprises a devise for calculating or determining the speed of the vehicle (such as a speedometer, odometers, radar speed gun, or global positioning system), that measures the actual speed of the vehicle and outputs this value to the computer. The computer would then use the actual speed of the vehicle to calculate the ejection rate of the load, instead of relying on an ideal speed the vehicle may not be able to maintain. Additionally, some embodiments of the subject matter of this application further comprise an acceleration controller which accepts output from the computer to adjust the speed of the vehicle if necessary.

FIGS. 2 and 3 are flow charts illustrating the movement of data through the disclosed system. In each figure initial measurements are taken at time T_{X}. At some interval, measurements are taken at T_{X+1}. Those paired measurements are used to determine the mass of the load and whether the speed of the ejection means should be changed to maintain the target ejection rate. The value of X as used in the flow charts increases by 1 with each new measurement. FIG. 3 also includes steps for obtaining data on the speed of the truck and for adjusting the speed of the truck in addition to, or an alternative to, adjusting the speed of the ejection means in order to maintain the targeted ejection rate. The term “equal” as used to refer to the actual and targeted ejection rates should be understood to mean “equal or within tolerance.”

Although several embodiments have been disclosed, the most preferred embodiment comprises a storage area with a load, at least one storage area scale, at least one reference scale, an ejection means and ejection means controller, and a vehicle speedometer. Components of the load are discharge by the actions of the ejection means as the vehicle moves across the terrain. The computer receives periodic input from the vehicle speedometer, reference scale or scales and the storage area scale or scales. Software residing in the computer's memory calculates the change in mass over time of the load as the vehicle moves and components of the load are ejected though the action of the ejection means using the above disclosed method of accounting for vertical acceleration. The computer also determines the change in area over time as a function of the vehicle's speed as measured by the speedometer. The change in mass over time and the change in area traveled over time are used by the computer to calculate the mass of the load's components ejected from the truck over the area traversed. Output from the computer to the ejection means controller increases or decreases the speed of the ejection means to maintain the ejection rate of components at or near the desired level for the operation. Optionally, the computer may also output instructions to the vehicle's acceleration means to adjust the speed of the vehicle to further maintain the desired ejection rate.

We claim:

1. A system for monitoring the change in mass of a load of changing mass between a first instant and a second instant while the mass is undergoing vertical acceleration comprising the steps of weighing the load of changing mass at a first instant, contemporaneously weighing a reference having a known mass undergoing the same vertical acceleration, calculating the mass of the load of changing mass from the measured weights and the reference, storing the calculated mass of the load of changing mass, weighing the load of changing mass at a second instant, contemporaneously weighing a reference of known mass, calculating the mass of the load of changing mass from the measured weights and reference, and calculating the difference between the two calculated mass values divided by the time distance between the first and the second instant,

2. A device for monitoring the change in mass over time of a load undergoing erratic vertical acceleration comprising a first scale, a second scale, and a computer, wherein
a) the first scale supports the load and transmits data corresponding to the weight of the load to the computer,
b) the second scale supports a known mass and transmits data corresponding to the weight of the known mass to the computer,
c) measurements received by the computer from the first scale and the second scale at a first time are used by software on the computer to calculate the mass of the load,
d) the calculated mass of the load at the first time is retained in the computer's memory,
e) measurements received by the computer from the first scale and the second scale at a second time are used by software on the computer to calculate the mass of the load,
f) the calculated mass of the load at the second time is retained in the computer's memory,
g) software on the computer calculates the change in mass between the first time calculations and second time calculations and,
h) software on the computer calculates the rate of change from the calculated change in mass and the time between the first and second times.

3. A vehicle for spreading the components of a load comprising a storage area, a first scale, a second scale, an ejection means, one or more ejection points, and a computer, wherein
a) the storage area comprises a load consisting of components,
b) the ejection means receives output from the computer, has a speeds and moves components of the load towards the ejection point,
c) said ejection point comprises a size,
d) the first scale supports the storage area transmits data corresponding to the weight of the load to the computer,
e) the second scale supports a known mass and transmits data corresponding to the weight of the known mass to the computer,
f) measurements received by the computer from the first scale and the second scale at a first time are used by software on the computer to calculate the mass of the load,
g) the calculated mass of the load at the first time is retained in the computer's memory,
h) measurements received by the computer from the first scale and the second scale at a second time are used by software on the computer to calculate the mass of the load,
i) the calculated mass of the load at the second time is retained in the computer's memory,
j) software on the computer calculates the change in mass between the first time calculations and second time calculations and,
k) software on the computer calculates the rate of change from the calculated change in mass and the time between the first and second times.
l) the computer's software outputs a signal the to the ejection means causing the ejection mean's speed to increase or decrease in response to difference between the calculated rate of change to a target rate of change.

4. The vehicle of claim 3 further comprising a means for measuring the vehicle's speed, said means comprising an output though which data is transmitted to the computer.

5. The vehicle of claim 4 further comprising speed controlling means receiving an output from the computer.
